(19) United States
(12) Patent Application Publication
(10) Pub. No.: US 2023/0265570 A1
(43) Pub. Date: Aug. 24, 2023

(54) Electrochemical Device

(71) Applicants: Hyundai Motor Company, Seoul (KR); Kai Corporation, Seoul (KR); Sambo Motors Co., Ltd, Daegu (KR)

(72) Inventors: Jung Han Yu, Yongin-si (KR); Chung Ho Suh, Seongnam-si (KR); Joo Young Kim, Yongin-si (KR); Kwi Seong Jeong, Yongin-si (KR); Young Jae Do, Daegu (KR); Sang Muk Park, Daegu (KR); Jae Man Kim, Daegu (KR); June Bak, Daegu (KR)

(21) Appl. No.: 17/831,737

(22) Filed: Jun. 3, 2022

(30) Foreign Application Priority Data
Feb. 22, 2022 (KR) 10-2022-0023241

(51) Int. Cl. C25B 13/00; C25B 1/04

(52) U.S. Cl. CPC C25B 13/00; C25B 1/04

(57) ABSTRACT

An embodiment electrochemical device includes a first separator including a first channel and a first land disposed in a first direction, a second separator including a second channel and a second land disposed in a second direction intersecting the first direction, the second separator being stacked on the first separator, and contact patterns provided on the first separator and disposed on the first channel so as to be in contact with the second separator.

### CROSS-REFERENCE TO RELATED APPLICATIONS

This application claims the benefit of Korean Patent Application No. 10-2022-0023241, filed on Feb. 22, 2022, which application is hereby incorporated herein by reference.

### TECHNICAL FIELD

The present disclosure relates to an electrochemical device.

### BACKGROUND

There is a consistently increasing need for research and development on alternative energy to cope with global warming and depletion of fossil fuel. Hydrogen energy is attracting attention as a practical solution for solving environment and energy issues.

In particular, because hydrogen has high energy density and properties suitable for application in a grid-scale, hydrogen is in the limelight as a future energy carrier.

A water electrolysis stack, which is one type of electrochemical devices, refers to a device that produces hydrogen and oxygen by electrochemically decomposing water. The water electrolysis stack may be configured by stacking several tens or several hundreds of water electrolysis cells (unit cells) in series.

A membrane-electrode assembly (MEA) is positioned at an innermost side of the unit cell of the water electrolysis stack. The membrane-electrode assembly includes a perfluorinated sulfonic acid ionomer-based electrolyte membrane capable of moving hydrogen ions (protons), and an anode and a cathode respectively disposed on two opposite surfaces of the electrolyte membrane. Hereinafter, the water electrolysis means polymer electrolyte membrane (PEM) water electrolysis.

In addition, a porous transport layer (PTL), a gas diffusion layer (GDL), and a gasket may be stacked on each of the outer portions (outer surfaces) of the membrane-electrode assembly (MEA) on which the anode and the cathode are stacked. A separator (or bipolar plate) may be disposed on an outer side (outer surface) of the PTL and the GDL. The separator includes flow paths (flow fields) through which a reactant, a coolant, and a product produced by a reaction flow, or the separator may include a structure that may be substituted for the flow paths.

In addition, in order to implement the water electrolysis stack by stacking the water electrolysis cells, sealability needs to be maintained between the respective separators (e.g., an anode separator and a cathode separator).

To this end, a gasket (sealing member) is disposed between the adjacent stacked separators. That is, the gasket serves to prevent a target fluid (e.g., water or hydrogen) flowing on one surface or the other surface of the separator from leaking to the outside of the water electrolysis cell.

Meanwhile, a state sealed by the gasket needs to be securely maintained to ensure safety, reliability, and stable performance of the water electrolysis cell.

Recently, there has been an attempt to implement a configuration in which a first channel of the anode separator through which a target fluid (e.g., water) flows and a second channel of the cathode separator through which a target fluid (e.g., hydrogen) flows are provided in directions intersecting each other (e.g., intersecting perpendicularly) in order to more effectively ensure sealing performance between the respective separators (e.g., the anode separator and the cathode separator).

In the related art, the sealing performance between the anode separator and the cathode separator may be ensured as the first and second channels are provided in the directions intersecting each other. However, a contact area (electrical contact area) between the anode separator and the cathode separator decreases (the contact area becomes smaller than a contact area in a structure in which first and second channels are parallel to each other). For this reason, there are problems in that electric current per unit area generated by the anode separator and the cathode separator is restricted (reduced), and cooling performance deteriorates. For this reason, there are problems in that performance, safety, and reliability of the water electrolysis cell deteriorate.

Therefore, recently, various studies have been conducted to improve safety and reliability while ensuring sealing performance of the water electrolysis cell, but the study results are still insufficient. Accordingly, there is a need to develop a technology to improve safety and reliability while ensuring sealing performance of the water electrolysis cell.

### SUMMARY

The present disclosure relates to an electrochemical device. Particular embodiments relate to an electrochemical device capable of improving safety and reliability while ensuring sealing performance.

Embodiments of the present disclosure provide an electrochemical device capable of improving safety and reliability while ensuring sealing performance.

In particular, embodiments of the present disclosure can ensure a contact area between adjacent separators while ensuring sealing performance between the adjacent separators.

Among other things, embodiments of the present disclosure can ensure a contact area between first and second separators while implementing a configuration in which a first channel of the first separator through which a target fluid flows and a second channel of the second separator through which a target fluid flows are provided in directions intersecting each other.

Embodiments of the present disclosure can improve performance and efficiency of an electrochemical device.

Embodiments of the present disclosure can improve structural rigidity of a separator and minimize deformation of and damage to the separator.

Embodiments of the present disclosure can improve safety, reliability, and a degree of alignment between separators.

Features of the embodiments are not limited to the above-mentioned features, but also include features or effects that may be understood from the solutions or embodiments described below.

An exemplary embodiment of the present disclosure provides an electrochemical device including a first separator having a first channel and a first land disposed in a first direction, a second separator having a second channel and a second land disposed in a second direction intersecting the first direction, the second separator being stacked on the first separator, and contact patterns provided on the first separator and disposed on the first channel so as to be in contact with the second separator.

This is to improve safety and reliability while ensuring sealability (sealing performance) of the electrochemical device.

That is, in the related art, the sealing performance between the anode separator and the cathode separator may be ensured as the first channels of the anode separator through which the target fluid (e.g., water) flows and the second channels of the cathode separator through which the target fluid (e.g., hydrogen) flows are provided in the directions intersecting each other. However, a contact area (electrical contact area) between the anode separator and the cathode separator decreases (the contact area becomes smaller than a contact area in a structure in which first and second channels are parallel to each other). For this reason, there are problems in that electric current per unit area generated by the anode separator and the cathode separator is restricted (reduced), and cooling performance deteriorates. For this reason, there are problems in that performance, safety, and reliability of the water electrolysis cell deteriorate.

In contrast, in an embodiment of the present disclosure, the contact patterns, which may be in contact with the second separator, are provided on the first channels of the first separator, such that the contact area between the first separator and the second separator may be additionally ensured by the contact patterns in addition to the area in which the protruding portions of the second separator, which correspond to the second channels, are in contact with the first separator. Therefore, it is possible to obtain an advantageous effect of ensuring the sealing performance between the first separator and the second separator, increasing the electric current per unit area generated by the first separator and the second separator, and improving the cooling performance.

The contact portions (positions) of the contact patterns with the second separator may be variously changed in accordance with required conditions and design specifications.

According to the exemplary embodiment of the present disclosure, the contact pattern may be in contact with a rear surface of the second land that faces the first separator.

According to the exemplary embodiment of the present disclosure, the contact pattern may be integrated with the first separator by partially processing a part of the first separator.

Since the contact pattern is formed by partially processing a part of the first separator as described above, it is possible to obtain an advantageous effect of simplifying the structure and manufacturing process and reducing manufacturing costs.

According to an exemplary embodiment of the present disclosure, the first direction may be perpendicular to the second direction.

The contact pattern may have various structures and shapes in accordance with required conditions and design specifications.

According to an exemplary embodiment of the present disclosure, the contact pattern may have a continuous straight shape in the second direction.

According to an exemplary embodiment of the present disclosure, a thickness of the first separator may be 0.08 to 0.6 mm.

Since the thickness of the first separator is 0.08 to 0.6 mm as described above, it is possible to obtain an advantageous effect of minimizing damage to the first separator and ensuring processability of the contact pattern during the process of processing (press processing) the contact pattern on the first separator made of metal.

According to an exemplary embodiment of the present disclosure, a width of the first channel in the second direction may be 1.5 to 7 mm.

Since the width of the first channel in the second direction is 1.5 to 7 mm as described above, it is possible to obtain an advantageous effect of ensuring processability of the contact pattern while minimizing deterioration in performance of the unit cell.

According to an exemplary embodiment of the present disclosure, the first channel and the contact pattern may satisfy Expression 1.

0.2 mm≤c′=(a−c)/2≤2 mm Expression 1

Here, a represents the width of the first channel in the second direction, c represents a contact length of the contact pattern being in contact with the second separator in the second direction, and c′ represents a length defined as (a−c)/2.

When c′((a−c)/2) is 0.2 mm or more and 2 mm or less as described above, it is possible to obtain an advantageous effect of ensuring a sufficient electrical contact area between the first separator and the second separator while ensuring processability of the contact pattern.

According to an exemplary embodiment of the present disclosure, the first channel and the contact pattern may satisfy Expression 2.

0.2 mm≤d′=(b−2e−d)/2≤2 mm Expression 2

Here, b represents a distance between a first reference line and a second reference line spaced apart from each other at two opposite ends of the contact pattern in the first direction based on the contact pattern, e represents an interval between the contact patterns disposed adjacent to each other in the first direction, d represents a contact width of the contact pattern being in contact with the second separator in the first direction, and d′ represents a length defined as (b−2e−d)/2.

When d′((b−2e−d)/2) is 0.2 mm or more and 2 mm or less as described above, it is possible to obtain an advantageous effect of ensuring a sufficient electrical contact area between the first separator and the second separator while ensuring processability of the contact pattern.

In particular, the intervals e between the contact patterns may be 1.5 mm or more.

According to an exemplary embodiment of the present disclosure, the contact pattern and the second separator may satisfy Expression 3.

d<i Expression 3

Here, d represents a contact width of the contact pattern being in contact with the second separator in the first direction, and i represents a width of the second land in the first direction.

As described above, the width of the second land in the first direction is larger than the contact width of the contact pattern being in contact with the second separator in the first direction. Therefore, the contact area between the first separator and the second separator may be additionally ensured, and the second separator may serve as a guide for guiding the alignment of the first separator at the time of stacking the unit cells. Therefore, it is possible to obtain an advantageous effect of improving a degree of alignment between the unit cells (separators) and improving safety and reliability.

According to an exemplary embodiment of the present disclosure, the first channel and the contact pattern may satisfy Expression 4.

0.4 mm≤h−g≤1.5 mm Expression 4

Here, g represents a thickness defined as a sum of a thickness of the first separator and a thickness of the first channel in a direction in which the unit cells are stacked, and h represents a thickness defined as a sum of the thickness of the first separator, a thickness of the first channel, and a thickness of the contact pattern in the direction in which the unit cells are stacked.

When h−g is 0.4 mm or more and 1.5 mm or less as described above, it is possible to obtain an advantageous effect of ensuring processability of the contact pattern while ensuring the movement effect (pulsation effect) of the target fluid.

According to an exemplary embodiment of the present disclosure, the contact pattern may include a contact portion spaced apart (protruding) from the first separator and being in contact with the second separator and connection portions configured to connect two opposite ends of the contact portion to the first separator.

In particular, the connection portions, together with the contact portion, may be in contact with the second separator. As described above, in an embodiment of the present disclosure, the contact portion is in contact with the second separator, and simultaneously, the connection portions are in contact with the second separator, such that the electrical contact area between the first separator and the second separator may further increase. Therefore, it is possible to obtain an advantageous effect of further improving performance and efficiency of the electrochemical device.

The connection portion may have various structures capable of being in contact with the second separator.

According to an exemplary embodiment of the present disclosure, the connection portion may be in surface contact with the second separator. To this end, the second land may include a land contact portion spaced apart from the second separator and a land connection portion configured to connect the land contact portion and the second separator. A boundary edge between the contact portion and the connection portion may have a first radius, a boundary edge between the land contact portion and the land connection portion may have a second radius smaller than the first radius, a boundary edge between the connection portion and the first separator may have a third radius, and a boundary edge between the land connection portion and the second separator may have a fourth radius larger than the third radius.

According to another embodiment of the present disclosure, the contact patterns may be provided in a part of the entire section of the first channel in the first direction.

According to an exemplary embodiment of the present disclosure, the first channel may include an inlet part, a central part disposed at a downstream side from the inlet part, and an outlet part disposed at a downstream side from the central part, and the contact pattern may be provided on at least any one of the inlet part, the central part, and the outlet part.

According to an exemplary embodiment of the present disclosure, the first channel may be provided in plural, the first land may be provided in plural, the plurality of first channels and the plurality of first lands may be alternately disposed in the second direction, and the contact pattern may be provided on at least any one of the plurality of first channels.

According to an exemplary embodiment of the present disclosure, the first channel may be provided in plural, the first land may be provided in plural, the plurality of first channels and the plurality of first lands may be alternately disposed in the second direction, and the contact pattern provided on any one of the plurality of first channels may be spaced, in the first direction, apart from the contact pattern provided on another first channel.

### BRIEF DESCRIPTION OF THE DRAWINGS

FIG. 1 is a view for explaining a first separator of an electrochemical device according to an embodiment of the present disclosure.

FIG. 2 is a view for explaining a second separator of the electrochemical device according to an embodiment of the present disclosure.

FIG. 3 is a view for explaining a land and a channel of the electrochemical device according to an embodiment of the present disclosure.

FIG. 4 is a cross-sectional view taken along line D-D in FIG. 3.

FIG. 5 is a cross-sectional view taken along line E-E in FIG. 3.

FIG. 6 is a cross-sectional view taken along line F-F in FIG. 3.

FIG. 7 is a cross-sectional view taken along line G-G in FIG. 3.

FIG. 8 is a view for explaining a contact pattern of the electrochemical device according to an embodiment of the present disclosure.

FIG. 9 is a cross-sectional view taken along line A-A in FIG. 8.

FIG. 10 is a cross-sectional view taken along line B-B in FIG. 8.

FIG. 11 is a cross-sectional view taken along line C-C in FIG. 8.

FIG. 12 is a view for explaining a modified example of the contact pattern of the electrochemical device according to an embodiment of the present disclosure.

FIGS. 13 to 15 are views for explaining another example of the contact pattern of the electrochemical device according to an embodiment of the present disclosure.

### DETAILED DESCRIPTION OF ILLUSTRATIVE EMBODIMENTS

Hereinafter, exemplary embodiments of the present disclosure will be described in detail with reference to the accompanying drawings.

However, the technical spirit of the present disclosure is not limited to the embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as having the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of distinguishing one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

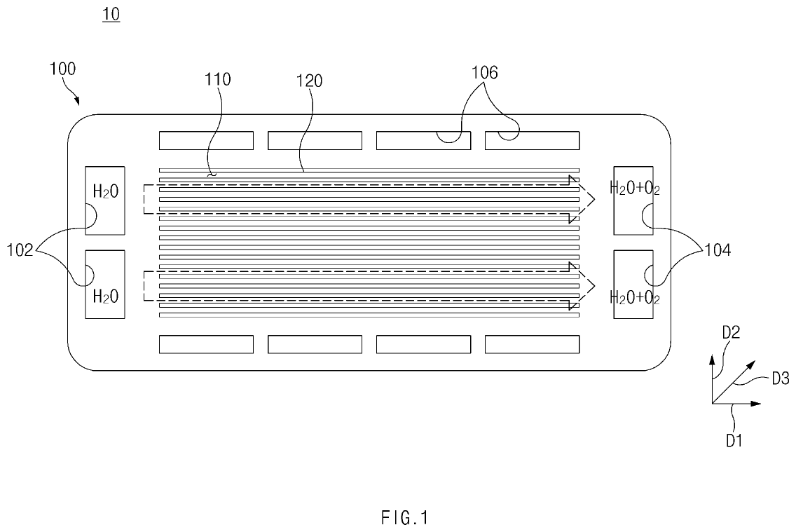

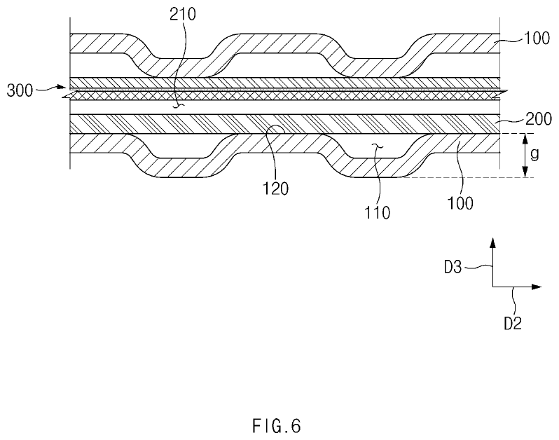

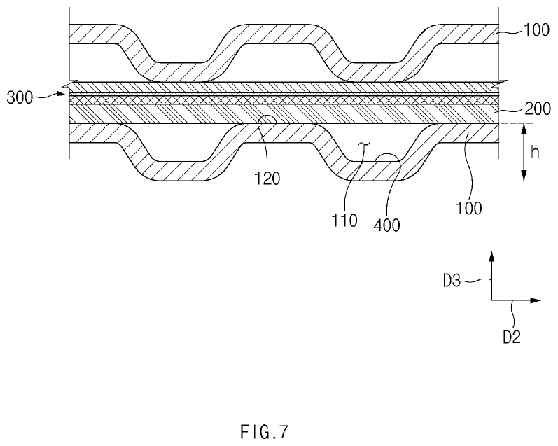

Referring to FIGS. 1 to 15, an electrochemical device 10 includes a first separator 100 having first channels 110 and first lands 120 provided in a first direction, a second separator 200 having second channels 210 and second lands 220 provided in a second direction intersecting the first direction, the second separator 200 being stacked on the first separator 100, and contact patterns 400 provided on the first separator 100 and disposed on the first channels 110 so as to be in contact with the second separator 200.

For reference, in the embodiments of the present disclosure, the electrochemical device 10 includes both a water electrolysis stack configured to produce hydrogen and oxygen by electrochemically decomposing water and a fuel cell stack configured to generate electrical energy through a chemical reaction of fuel (e.g., hydrogen).

Hereinafter, an example will be described in which the electrochemical device 10 according to an embodiment of the present disclosure is used as the water electrolysis stack that produces hydrogen and oxygen by decomposing water through an electrochemical reaction.

The water electrolysis stack may be configured by stacking a plurality of unit cells in a reference stacking direction (e.g., an upward/downward direction based on FIG. 1).

More specifically, the unit cell may include a reaction layer 300, the first separator 100 stacked on one surface of the reaction layer 300, and the second separator 200 stacked on the other surface of the reaction layer 300. The water electrolysis stack may be configured by stacking the plurality of unit cells in the reference stacking direction and then assembling endplates (not illustrated) to two opposite ends of the plurality of unit cells.

The reaction layer 300 may have various structures capable of generating the electrochemical reaction of the target fluid (e.g., water). The present disclosure is not restricted or limited by the type and structure of the reaction layer 300.

For example, the reaction layer 300 may include a membrane electrode assembly (MEA) 310, a first porous transport layer 320 being in close contact with one surface of the membrane electrode assembly 310, and a second porous transport layer 330 being in close contact with the other surface of the membrane electrode assembly 310.

The membrane electrode assembly 310 may be variously changed in structure and material in accordance with required conditions and design specifications, and the present disclosure is not limited or restricted by the structure and material of the membrane electrode assembly 310.

For example, the membrane electrode assembly 310 may be configured by attaching catalyst electrode layers (e.g., an anode layer and a cathode layer), in which electrochemical reactions are generated, to two opposite surfaces of an electrolyte membrane (e.g., a perfluorinated sulfonic acid ionomer-based electrolyte membrane).

The first and second porous transport layers 320 and 330 may serve to uniformly distribute the target fluid and each have a porous structure having pores with predetermined sizes.

For reference, water supplied to the anode layer, which is an oxidation electrode for the water electrolysis, is separated into hydrogen ions (protons), electrons, and oxygen. The hydrogen ions move to the cathode layer, which is a reduction electrode, through the electrolyte membrane, and the electrons move to a cathode through an external circuit. In addition, the oxygen may be discharged through an anode outlet, and the hydrogen ions and the electrons may be converted into hydrogen at the cathode.

Referring to FIGS. 1 to 11, the first and second separators 100 and 200, together with the reaction layer 300, constitute a single unit cell (water electrolysis cell). The first and second separators 100 and 200 serve to block hydrogen and water separated by the reaction layer 300 and ensure flow paths (flow fields) through which hydrogen and water flow.

In addition, the first and second separators 100 and 200 may also serve to distribute heat, which is generated from the unit cell, to the entire unit cell, and the excessively generated heat may be discharged to the outside by water flowing along the first and second separators 100 and 200.

For reference, in an embodiment of the present disclosure, the separators (the first separator and the second separator) are defined as including both the anode separator and the cathode separator that independently define the flow paths (channels) for water (or water and oxygen) and the flow paths (channels) for hydrogen in the water electrolysis stack.

Hereinafter, an example will be described in which the first separator 100 serves as the anode separator that defines the flow paths (channels) for water (or water and oxygen) in the water electrolysis stack, and the second separator 200 serves as the cathode separator that defines the flow paths (channels) for hydrogen in the water electrolysis stack. Alternatively, the first separator 100 may serve as the cathode separator, and the second separator 200 may serve as the anode separator.

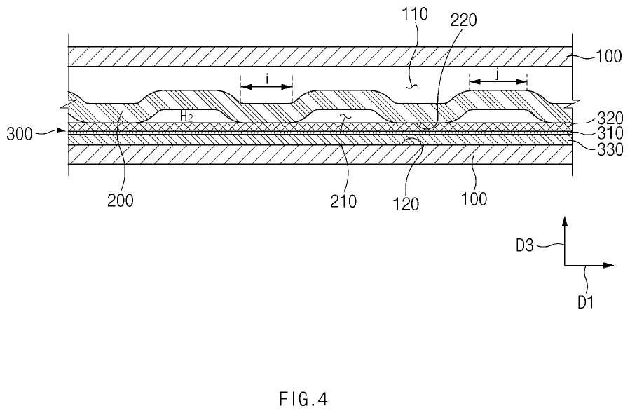

More specifically, the first separator 100 may serve to cover one surface of the reaction layer 300 (a bottom surface of the reaction layer based on FIG. 4). The first channels 110 and the first lands 120 are provided in the first direction on one surface of the first separator 100 that faces the reaction layer 300.

Hereinafter, an example will be described in which the first direction is defined as a horizontal direction (leftward/rightward direction) based on FIG. 4. Alternatively, the first direction may be defined as a vertical direction (e.g., based on FIG. 4) or other directions.

The first lands 120 are in contact with the reaction layer 300 and thus serve as electrical passageways. The first channels 110 are disposed between the adjacent first lands 120 to form reaction regions for the electrochemical reaction. For example, the first channel 110 may serve as an anode channel through which water (or water and oxygen) flows.

The first separator 100 may have various structures having the first channels 110 and be made of various materials. The present disclosure is not restricted or limited by the structure and material of the first separator 100.

For example, the first separator 100 may be provided in the form of an approximately quadrangular plate, and the first channels 110 may be provided on an approximately central part 110b of the first separator 100. According to another embodiment of the present disclosure, the first separator may have a circular shape or other shapes.

According to an exemplary embodiment of the present disclosure, the first separator 100 may be made of metal (e.g., titanium, stainless steel, Inconel, or aluminum). According to another embodiment of the present disclosure, the first separator may be made of another material such as graphite or a carbon composite. Hereinafter, an example will be described in which the first separator 100 is made of metal.

The first channel 110 may have various structures in accordance with required conditions and design specifications. The present disclosure is not restricted or limited by the structure of the first channel 110.

For example, the first channel 110 may have a straight shape defined in the first direction. Alternatively, the first channel 110 may have a curved shape or other shapes.

In addition, the first separator 100 has a plurality of manifold flow paths 102, 104, and 106 through which water (or water and oxygen) or hydrogen enters and exits the first separator 100 (e.g., supplied and discharged).

For example, first-first manifold flow paths 102, through which water is supplied, may be provided at one end (left end based on FIG. 1) of the first separator 100 based on the first direction. First-second manifold flow paths 104, through which water and oxygen are discharged, may be provided at the other end (right end based on FIG. 1) of the first separator 100 based on the first direction. The water introduced into the first-first manifold flow paths 102 may pass through the first channels 110 and then be discharged through the first-second manifold flow paths 104.

In addition, first-third manifold flow paths 106, through which hydrogen is discharged, may be provided at two opposite ends (upper and lower ends based on FIG. 1) of the first separator 100 based on the second direction.

The respective manifold flow paths 102, 104, and 106 may be variously changed in number and structure in accordance with required conditions and design specifications. The present disclosure is not restricted or limited by the numbers and structures of the respective manifold flow paths 102, 104, and 106.

The second separator 200 may serve to cover the other surface of the reaction layer 300 (a top surface of the reaction layer 300 based on FIG. 4). The second channels 210 and the second lands 220 are provided in the second direction intersecting the first direction and disposed on one surface of the second separator 200 that faces the reaction layer 300.

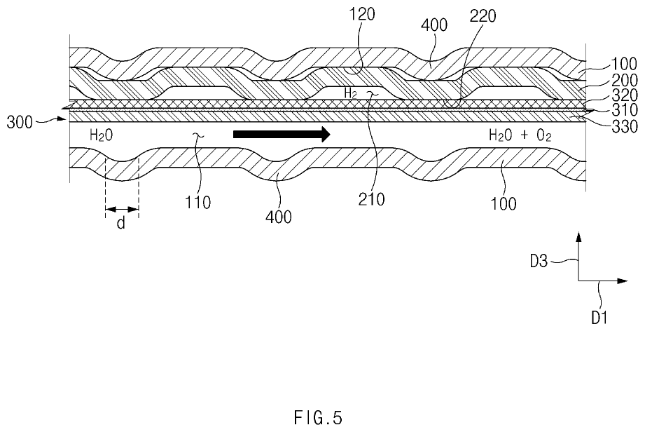

In addition, the second separator 200 is disposed to face the other surface (the bottom surface based on FIG. 5) of the first separator 100 of another adjacent unit cell. More specifically, protruding portions of the second separator 200, which correspond to the second channels 210, may be in (close) contact with one surface (the bottom surface based on FIG. 5) of the first separator 100.

For example, the first direction may be defined as being perpendicular to the second direction. Hereinafter, an example will be described in which the second direction is defined as the vertical direction (upward/downward direction) based on FIG. 4. Alternatively, the second direction may be defined as the horizontal direction (e.g., based on FIG. 4) or other directions.

For reference, in an embodiment of the present disclosure illustrated and described above, the example has been described in which the second direction is defined as being perpendicular to the first direction. However, according to another embodiment of the present disclosure, the second direction may be defined as being inclined with respect to the first direction.

The second lands 220 are in contact with the reaction layer 300 and thus serve as electrical passageways. The second channels 210 are disposed between the adjacent second lands 220 to form reaction regions for the electrochemical reaction. For example, the second channel 210 may serve as a cathode channel through which hydrogen flows.

The second separator 200 may have various structures having the second channels 210 and be made of various materials. The present disclosure is not restricted or limited by the structure and material of the second separator 200.

For example, the second separator 200 may be provided in the form of an approximately quadrangular plate corresponding to the first separator 100. The second channels 210 may be provided on an approximately central part 110b of the second separator 200. According to another embodiment of the present disclosure, the second separator 200 may have a circular or other shapes.

According to an exemplary embodiment of the present disclosure, the second separator 200 may be made of metal (e.g., titanium, stainless steel, Inconel, or aluminum). According to another embodiment of the present disclosure, the second separator may be made of another material such as graphite or a carbon composite. Hereinafter, an example will be described in which the second separator 200 is made of metal.

The second channel 210 may have various structures in accordance with required conditions and design specifications. The present disclosure is not restricted or limited by the structure of the second channel 210.

For example, the second channel 210 may have a straight shape defined in the second direction. Alternatively, the second channel 210 may have a curved shape or other shapes.

In addition, the second separator 200 has a plurality of manifold flow paths 202, 204, and 206 through which hydrogen or water (or water and oxygen) enters and exits the second separator 200 (e.g., supplied and discharged).

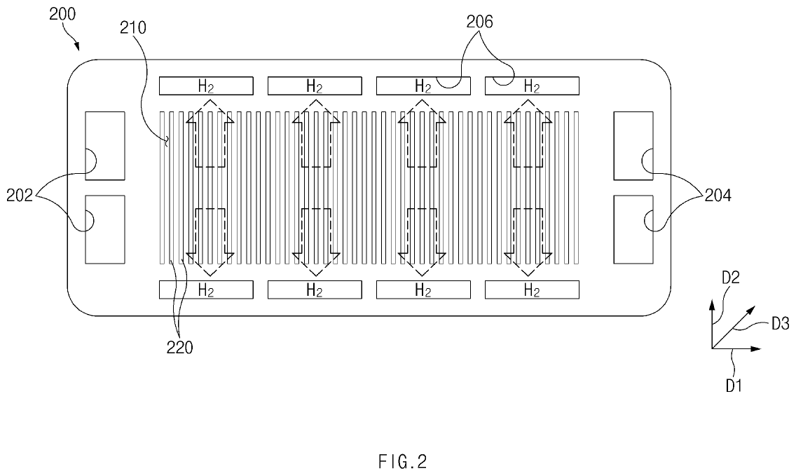

For example, second-third manifold flow paths 206, through which hydrogen is discharged, may be provided at two opposite ends (upper and lower ends based on FIG. 2) of the second separator 200 based on the second direction. The hydrogen flowing along the second channels 210 may be discharged through the second-third manifold flow paths 206.

In addition, second-first manifold flow paths 204, through which water is supplied, may be provided at one end (right end based on FIG. 2) of the second separator 200 based on the first direction. Second-second manifold flow paths 202, through which water and oxygen are discharged, may be provided at the other end (left end based on FIG. 2) of the second separator 200 based on the second direction.

The respective manifold flow paths 202, 204, and 206 may be variously changed in number and structure in accordance with required conditions and design specifications. The present disclosure is not restricted or limited by the numbers and structures of the respective manifold flow paths 202, 204, and 206.

As described above, in an embodiment of the present disclosure, the first channel 110 of the first separator 100 and the second channel 210 of the second separator 200 are disposed to be perpendicular to each other. Further, the manifold flow paths (e.g., the first-third manifold flow path and the second-third manifold flow path) for the supply and discharge of hydrogen and the manifold flow paths (e.g., the first-first manifold flow path, the first-second manifold flow path, the second-first manifold flow path, and the second-second manifold flow path) for the supply and discharge of water (or water and oxygen) are disposed at predetermined intervals so as to be perpendicular to one another. Therefore, it is possible to obtain an advantageous effect of improving safety and reliability and effectively ensuring sealing performance (particularly, sealing performance for high-pressure hydrogen) between the first separator 100 and the second separator 200.

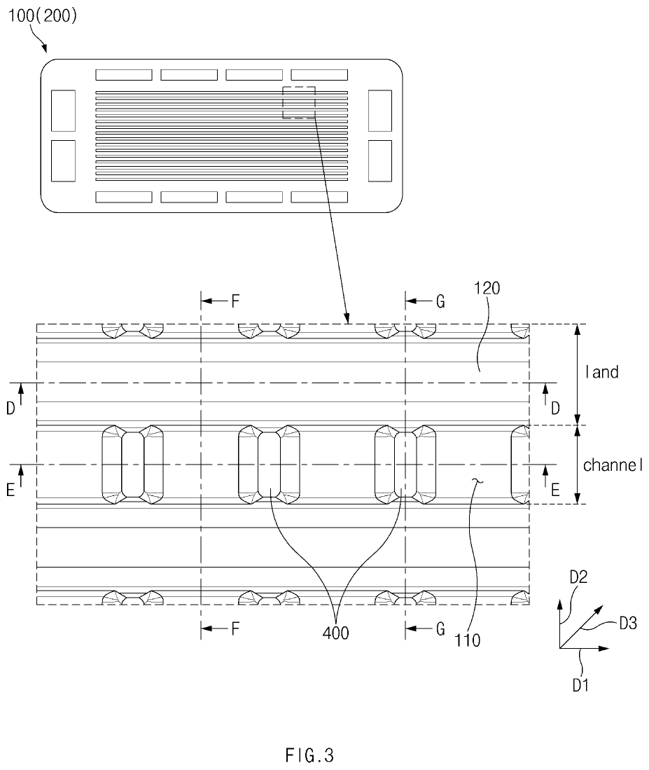

Referring to FIGS. 3 to 11, the contact patterns 400 serve to additionally ensure the contact area (electrical contact area) between the first separator 100 and the second separator 200.

In this case, the configuration in which the contact area between the first separator 100 and the second separator 200 is additionally ensured means that the contact area between the first separator 100 and the second separator 200 is additionally ensured in addition to the area in which the protruding portions of the second separator 200, which correspond to the second channels 210, are in contact with the first separator 100.

More specifically, the contact patterns 400 are provided on the first separator 100 and disposed on the first channels 110 so as to be in contact with the second separator 200.

This is based on the fact that when the first channel 110 of the first separator 100 and the second channel 210 of the second separator 200 are disposed to be perpendicular to each other, the sealing performance between the first separator 100 and the second separator 200 may be stably ensured, but the contact area between the first separator 100 and the second separator 200 is decreased, the electric current per unit area generated by the first separator 100 and the second separator 200 is restricted (reduced), and the cooling performance deteriorates.

In contrast, in an embodiment of the present disclosure, the contact patterns 400, which may be in contact with the second separator 200, are provided on the first channels 110 of the first separator 100, such that the contact area between the first separator 100 and the second separator 200 may be additionally ensured by the contact patterns 400 in addition to the area (basic contact area) in which the protruding portions of the second separator 200, which correspond to the second channels 210, are in contact with the first separator 100. Therefore, it is possible to obtain an advantageous effect of ensuring the sealing performance between the first separator 100 and the second separator 200, increasing the electric current per unit area generated by the first separator 100 and the second separator 200, and improving the cooling performance.

In other words, if no separate contact pattern 400 is provided on the first separator 100, the contact area between the first separator 100 and the second separator 200 may be defined as the area (basic contact area) in which the protruding portions of the second separator 200, which correspond to the second channels 210, are in contact with the first separator 100. In contrast, when the contact patterns 400 are provided on the first separator 100, the contact area between the first separator 100 and the second separator 200 may be defined as a total sum of the area (basic contact area) in which the protruding portions of the second separator 200, which correspond to the second channels 210, are in contact with the first separator 100 and the area (additional contact area) in which the contact patterns 400 are in contact with the second separator 200.

The contact portions (positions) of the contact patterns 400 with the second separator 200 may be variously changed in accordance with required conditions and design specifications. The present disclosure is not restricted or limited by the contact portions of the contact patterns 400 with the second separator 200.

For example, the contact patterns 400 may be provided on the first channels 110 so as to be in contact with rear surfaces (upper surfaces based on FIG. 5) of the second lands 220 that face the first separator 100.

Hereinafter, an example will be described in which the plurality of first channels 110 and the plurality of first lands 120 are alternately disposed in the second direction, and the contact patterns 400 are disposed at regular intervals on each of the first channels 110.

In particular, the contact pattern 400 may be integrated with the first separator 100 by partially processing a part of the first separator 100.

More specifically, the contact pattern 400 may protrude from the other surface (a bottom surface based on FIG. 5) of the first separator 100 by partially pressing (e.g., performing press processing on) one surface (an upper surface based on FIG. 5) of the first separator 100 that corresponds to the first channel 110.

More particularly, the contact pattern 400 may be formed together with the first channel 110 during a process of forming the first channel 110 on the first separator 100. Since the contact pattern 400 is formed by partially processing a part of the first separator 100 as described above, it is possible to obtain an advantageous effect of simplifying the structure and manufacturing process and reducing manufacturing costs.

In the embodiment of the present disclosure illustrated and described above, the example has been described in which the contact pattern 400 is formed integrally with the first separator 100 by partially processing a part of the first separator 100. However, according to another embodiment of the present disclosure, the contact pattern may be formed by attaching or coupling a separate member to the first separator. Alternatively, the contact pattern may be formed on the first separator by etching, cutting processing, or the like.

The contact pattern 400 may have various structures and shapes in accordance with required conditions and design specifications. The present disclosure is not restricted or limited by the structure and shape of the contact pattern 400.

According to an exemplary embodiment of the present disclosure, the contact pattern 400 may have a continuous straight shape that traverses the first channel 110 in the second direction.

According to another embodiment of the present disclosure, the contact pattern may have a curved shape, a dome shape, a ring shape, or other shapes.

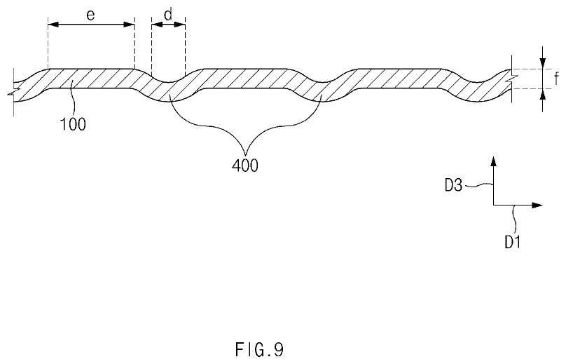

Referring to FIGS. 3 to 11, in an exemplary embodiment of the present disclosure, a thickness (see f in FIG. 9) of the first separator 100 may be 0.08 to 0.6 mm.

When the thickness f of the first separator 100 is 0.08 to 0.6 mm as described above, it is possible to obtain an advantageous effect of minimizing damage to the first separator 100 and ensuring processability of the contact pattern 400 during the process of processing (press processing) the contact pattern 400 on the first separator 100 made of metal (e.g., titanium or stainless steel).

That is, if the thickness of the first separator 100 is smaller than 0.08 mm, the first separator 100 may be easily damaged during the process of processing the contact pattern 400 on the first separator 100. In contrast, if the thickness of the first separator 100 is larger than 0.6 mm, structural rigidity of the first separator 100 may be ensured, but there are problems in that processability of the contact pattern 400 deteriorates, and it is difficult to accurately process the contact pattern 400 having a desired structure and shape. Therefore, the thickness f of the first separator 100 may be 0.08 to 0.6 mm. More particularly, the thickness f of the first separator 100 may be 0.4 to 0.6 mm.

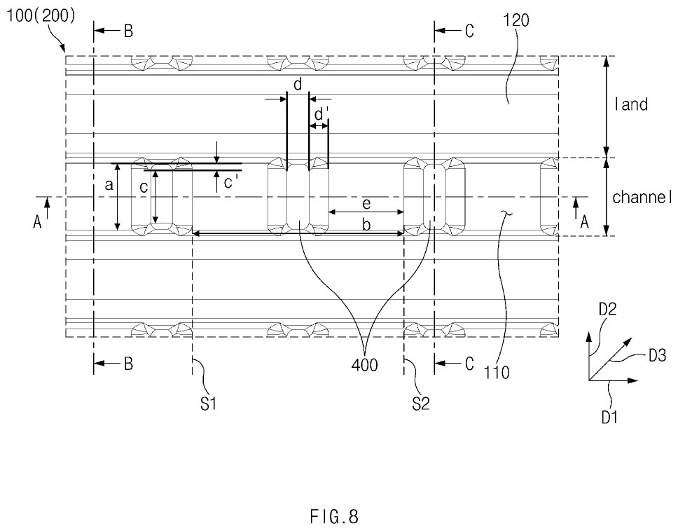

Referring to FIGS. 3 to 11, in an exemplary embodiment of the present disclosure, a width (see a in FIG. 8) of the first channel 110 in the second direction may be 1.5 to 7 mm.

When the width a of the first channel 110 in the second direction is 1.5 to 7 mm as described above, it is possible to obtain an advantageous effect of ensuring processability of the contact pattern 400 while minimizing deterioration in performance of the unit cell.

That is, if the width of the first channel 110 in the second direction is smaller than 1.5 mm, there is a problem in that it is difficult to perform the process of processing the contact pattern 400 on the first channel 110. In contrast, if the width of the first channel 110 in the second direction is larger than 7 mm, there is a problem in that performance of the unit cell deteriorates. Therefore, the width a of the first channel 110 in the second direction may be 1.5 to 7 mm.

Referring to FIGS. 3 to 11, in an exemplary embodiment of the present disclosure, the first channel 110 and the contact pattern 400 may satisfy Expression 1 below.

0.2 mm≤c′=(a−c)/2≤2 mm Expression 1

Here, a represents the width of the first channel 110 in the second direction, c represents a contact length of the contact pattern 400 being in contact with the second separator 200 in the second direction, and c′ represents a length defined as (a−c)/2.

When c′((a−c)/2) is 0.2 mm or more and 2 mm or less as described above, it is possible to obtain an advantageous effect of ensuring a sufficient electrical contact area between the first separator 100 and the second separator 200 while ensuring processability of the contact pattern 400.

That is, when c′((a−c)/2) is less than 0.2 mm, there is a problem in that it is difficult to perform the process of processing the contact pattern 400 on the first channel 110. In contrast, if c′((a−c)/2) is more than 2 mm, there is a problem in that it is difficult to ensure a sufficient contact area implemented by the contact pattern 400 (electrical contact area between the first separator 100 and the second separator 200). Therefore, c′((a−c)/2) may be 0.2 mm or more and 2 mm or less.

Referring to FIGS. 3 to 11, in an exemplary embodiment of the present disclosure, the first channel 110 and the contact pattern 400 may satisfy Expression 2 below.

0.2 mm≤d′=(b−2e−d)/2≤2 mm Expression 2

Here, b represents a distance (reference pitch) between a first reference line S1 and a second reference line S2 spaced apart from each other at two opposite ends of the contact pattern 400 in the first direction based on the contact pattern 400, e represents an interval between the contact patterns 400 disposed adjacent to each other in the first direction, d represents a contact width of the contact pattern 400 being in contact with the second separator 200 in the first direction, and d′ represents a length defined as (b−2e−d)/2.

When d′((b−2e−d)/2) is 0.2 mm or more and 2 mm or less as described above, it is possible to obtain an advantageous effect of ensuring a sufficient electrical contact area between the first separator 100 and the second separator 200 while ensuring processability of the contact pattern 400.

That is, when d′((b−2e−d)/2) is less than 0.2 mm, there is a problem in that it is difficult to perform the process of processing the contact pattern 400 on the first channel 110. In contrast, if d′((b−2e−d)/2) is more than 2 mm, there is a problem in that it is difficult to ensure a sufficient contact area implemented by the contact pattern 400 (electrical contact area between the first separator 100 and the second separator 200). Therefore, d′((b−2e−d)/2) may be 0.2 mm or more and 2 mm or less.

In particular, the interval e between the contact patterns 400 may be 1.5 mm or more.

That is, when the interval e between the contact patterns 400 is smaller than 1.5 mm, there are problems in that it is difficult to perform the process of processing the first channel 110 on the first separator 100, and the contact area between the first separator 100 and the second separator 200 decreases. Therefore, the interval e between the contact patterns 400 may be 1.5 mm or more.

Referring to FIGS. 3 to 11, in an exemplary embodiment of the present disclosure, the contact pattern 400 and the second separator 200 may satisfy Expression 3 below.

d<i Expression 3

Here, d represents a contact width of the contact pattern 400 being in contact with the second separator 200 in the first direction, and i represents a width of the second land 220 in the first direction.

As described above, the width (see i in FIG. 4) of the second land 220 in the first direction is larger than the contact width (see d in FIG. 8) of the contact pattern 400 being in contact with the second separator 200 in the first direction. Therefore, the contact area between the first separator 100 and the second separator 200 may be additionally ensured, and the second separator 200 may serve as a guide for guiding the alignment of the first separator 100 at the time of stacking the unit cells. Therefore, it is possible to obtain an advantageous effect of improving a degree of alignment between the unit cells (separators) and improving safety and reliability. For reference, ‘j’ in FIG. 4 indicates a width of the second channel 210 in the first direction.

Referring to FIGS. 3 to 11, in an exemplary embodiment of the present disclosure, the first channel 110 and the contact pattern 400 may satisfy Expression 4 below.

0.4 mm≤h−g≤1.5 mm Expression 4

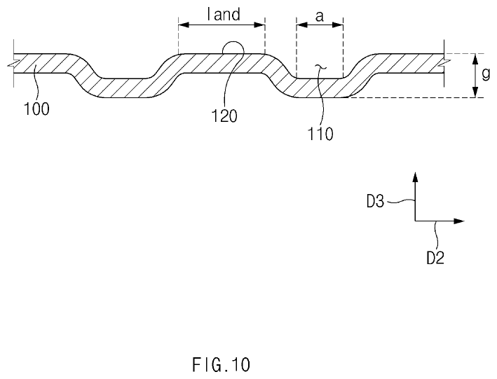

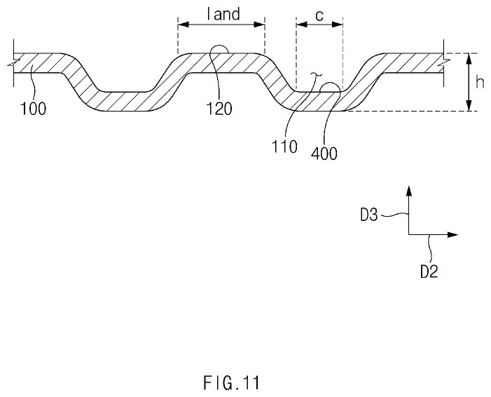

Here, g represents a thickness (see FIG. 10) defined as a sum of a thickness of the first separator 100 and a thickness of the first channel 110 in a direction D3 in which the unit cells are stacked, and h represents a thickness (see FIG. 11) defined as a sum of the thickness of the first separator 100, a thickness of the first channel 110, and a thickness of the contact pattern 400 in the direction D3 in which the unit cells are stacked.

When h−g is 0.4 mm or more and 1.5 mm or less as described above, it is possible to obtain an advantageous effect of ensuring processability of the contact pattern 400 while ensuring the movement effect (pulsation effect) of the target fluid.

That is, if h−g is less than 0.4 mm, the movement effect (pulsation effect) of the target fluid moving along the first channel 110 may deteriorate. In contrast, if h−g is more than 1.5 mm, there is a problem in that the process of processing the contact pattern 400 on the first channel 110 is restricted. Therefore, h−g may be 0.4 mm or more and 1.5 mm or less.

According to an exemplary embodiment of the present disclosure, the thickness g defined as a sum of the thickness of the first separator 100 and the thickness of the first channel 110 may be defined as having (+) tolerance, and the thickness h defined as a sum of the thickness of the first separator 100, the thickness of the first channel 110, and the thickness of the contact pattern 400 may be defined as having (−) tolerance.

Since the thickness g has the (+) tolerance and the thickness h has the (−) tolerance as described above, the protruding portions of the second separator 200, which correspond to the second channels 210, come into contact with the first separator 100 first to ensure the basic contact area at the time of stacking the unit cells, and then the contact patterns 400 are brought into contact with the second separator 200 by additional fastening pressure. Therefore, it is possible to additionally ensure the contact area between the first separator 100 and the second separator 200 (additionally ensure the contact area implemented by the contact patterns 400).

Meanwhile, in the embodiment of the present disclosure illustrated and described above, the example has been described in which only a part (e.g., a contact portion) of the contact pattern 400 is solely in contact with the second separator 200. However, according to another embodiment of the present disclosure, two or more points of the contact pattern 400′ may be in contact with the second separator 200.

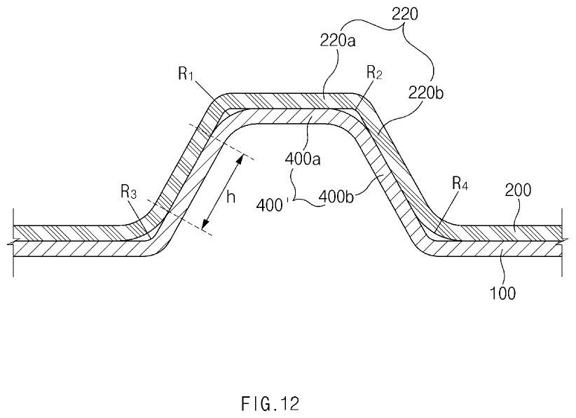

For example, referring to FIG. 12, the contact pattern 400′ may include a contact portion 400a spaced apart (protruding) from the first separator 100 and being in contact with the second separator 200 and connection portions 400b configured to connect two opposite ends of the contact portion 400a to the first separator 100.

In particular, the connection portions 400b, together with the contact portion 400a, may be in contact with the second separator 200.

As described above, in an embodiment of the present disclosure, the contact portion 400a is in contact with the second separator 200, and simultaneously, the connection portions 400b are in contact with the second separator 200, such that the electrical contact area between the first separator 100 and the second separator 200 may further increase. Therefore, it is possible to obtain an advantageous effect of further improving performance and efficiency of the electrochemical device 10.

The connection portion 400b may have various structures capable of being in contact with the second separator 200. The present disclosure is not restricted or limited by the structure and shape of the connection portion 400b.

In particular, the connection portion 400b may have a straight shape that may be in surface contact with the second separator 200. To this end, the second land 220 includes a land contact portion 220a spaced apart from the second separator 200 and land connection portions 220b configured to connect the land contact portion 220a and the second separator 200. A boundary edge between the contact portion 400a and the connection portion 400b may have a first radius R1, a boundary edge between the land contact portion 220a and the land connection portion 220b may have a second radius R2 smaller than the first radius, a boundary edge between the connection portion 400b and the first separator 100 may have a third radius R3, and a boundary edge between the land connection portion 220b and the second separator 200 may have a fourth radius R4 larger than the third radius R3. It can be understood that ‘h’ in FIG. 12 indicates a section in which the connection portion 400b is in surface contact with the second separator 200.

In the embodiment of the present disclosure illustrated and described above, the example has been described in which the connection portion 400b has an approximately straight shape and is in surface contact with the second separator 200. However, according to another embodiment of the present disclosure, the connection portion may have a curved shape (e.g., arc shape) that may be in line contact (or point contact) with the second separator.

In the embodiment of the present disclosure illustrated and described above, the example has been described in which the contact patterns 400 are provided in the entire section of the first channel 110 in the first direction. However, according to another embodiment of the present disclosure, the contact patterns 400 may be provided in a part of the entire section of the first channel 110 in the first direction.

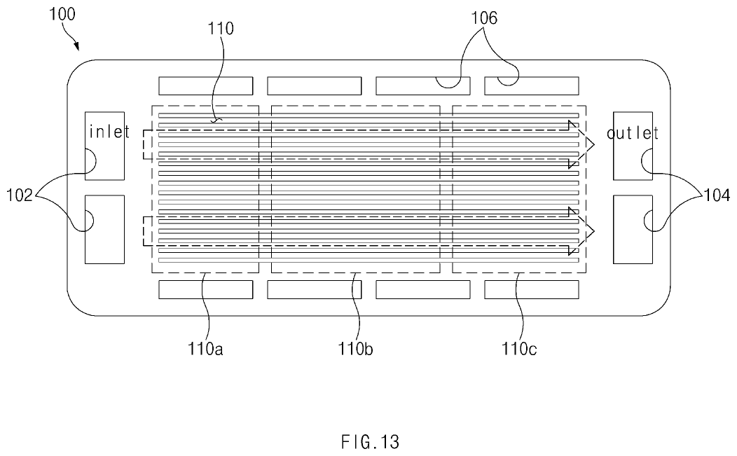

That is, referring to FIG. 13, the first channel 110 may include an inlet part 110a, a central part 110b disposed at a downstream side from the inlet part 110a, and an outlet part 110c disposed at a downstream side from the central part 110b. The contact pattern 400 may be provided on at least any one of the inlet part 110a, the central part 110b, and the outlet part 110c.

For example, the contact patterns 400 may be provided only on the central part 110b or on both the inlet part 110a and the central part 110b. Alternatively, the contact patterns 400 may be provided only on the outlet part 110c or on both the inlet part 110a and the outlet part 110c.

In addition, in the embodiment of the present disclosure illustrated and described above, the example has been described in which the plurality of first channels 110 and the plurality of first lands 120 are alternately disposed in the second direction, and the contact patterns 400 are disposed at regular intervals on each of the first channels 110. However, according to another embodiment of the present disclosure, the contact patterns 400 may be provided on only some of the plurality of first channels, or the contact patterns 400 may be arranged irregularly.

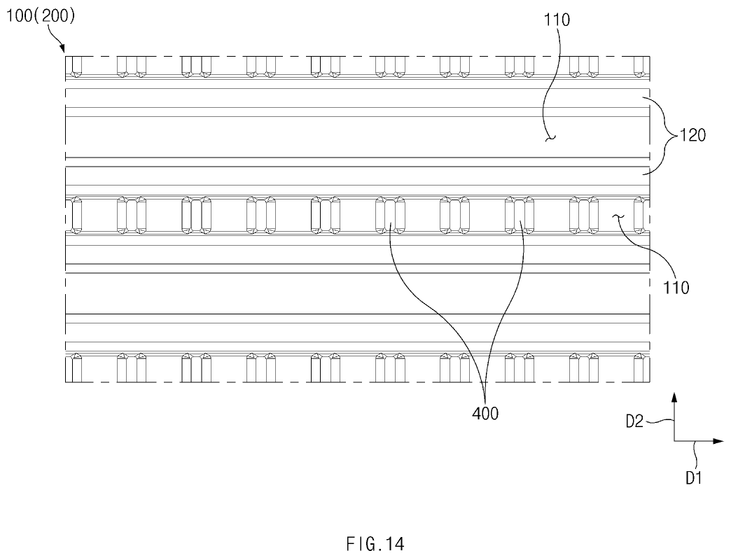

Referring to FIG. 14, the plurality of first channels 110 and the plurality of first lands 120 may be alternately disposed in the second direction, and the contact patterns 400 may be provided on only some of the plurality of first channels 110.

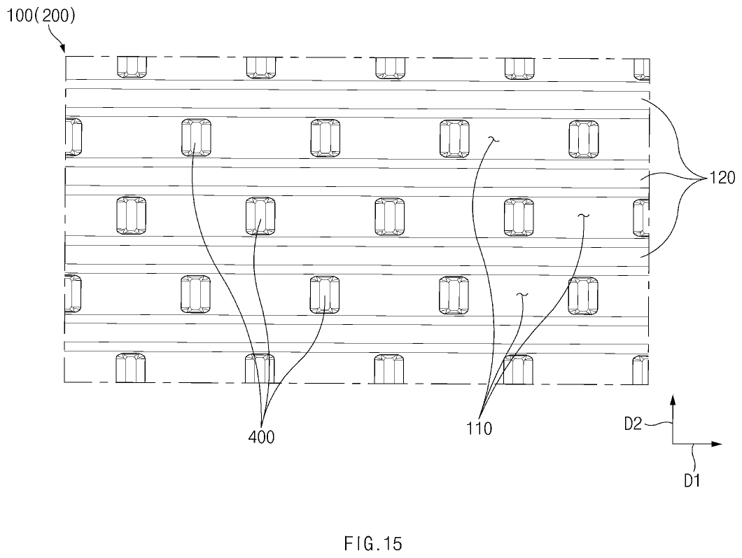

Referring to FIG. 15, the plurality of first channels 110 and the plurality of first lands 120 may be alternately disposed in the second direction, and the contact pattern 400 provided on any one of the plurality of first channels 110 may be spaced, in the first direction, apart from the contact pattern 400 provided on another first channel 110. For example, the contact patterns 400 provided on the different first channels 110 may be disposed in a direction inclined by about 45 degrees with respect to the first direction. Alternatively, the plurality of contact patterns 400 may be arranged at irregular intervals. The present disclosure is not restricted or limited by the arrangement intervals and arrangement patterns of the contact patterns 400.

According to the embodiments of the present disclosure described above, it is possible to obtain an advantageous effect of improving safety and reliability while ensuring sealing performance.

In particular, according to the embodiments of the present disclosure, it is possible to obtain an advantageous effect of ensuring the contact area between the adjacent separators while ensuring sealing performance between the adjacent separators.

Among other things, according to the embodiments of the present disclosure, it is possible to obtain an advantageous effect of ensuring the contact area between first and second separators while implementing the configuration in which the first channel of the first separator through which a target fluid flows and the second channel of the second separator through which a target fluid flows are provided in directions intersecting each other.

In addition, according to the embodiments of the present disclosure, it is possible to obtain an advantageous effect of improving performance and efficiency of the electrochemical device.

In addition, according to the embodiments of the present disclosure, it is possible to obtain an advantageous effect of improving the structural rigidity of the separator and minimizing deformation of and damage to the separator.

In addition, according to the embodiments of the present disclosure, it is possible to obtain an advantageous effect of improving safety, reliability, and a degree of alignment between the separators.

While the embodiments have been described above, the embodiments are just illustrative and not intended to limit the present disclosure. It can be appreciated by those skilled in the art that various modifications and applications, which are not described above, may be made to the present embodiments without departing from the intrinsic features of the present embodiments. For example, the respective constituent elements specifically described in the embodiments may be modified and then carried out. Further, it should be interpreted that the differences related to the modifications and applications are included in the scope of the present disclosure defined by the appended claims.

What is claimed is:

1. An electrochemical device comprising:
a first separator comprising a first channel and a first land disposed in a first direction;
a second separator comprising a second channel and a second land disposed in a second direction intersecting the first direction, the second separator being stacked on the first separator; and
contact patterns provided on the first separator and disposed on the first channel so as to be in contact with the second separator.

2. The electrochemical device of claim 1, wherein the contact patterns are in contact with a rear surface of the second land that faces the first separator.

3. The electrochemical device of claim 1, wherein the contact patterns are integrated with the first separator.

4. The electrochemical device of claim 1, wherein the first direction is perpendicular to the second direction.

5. The electrochemical device of claim 1, wherein the contact patterns have a continuous straight shape in the second direction.

6. The electrochemical device of claim 1, wherein a thickness of the first separator is 0.08 to 0.6 mm.

7. The electrochemical device of claim 1, wherein a width of the first channel in the second direction is 1.5 to 7 mm.

8. The electrochemical device of claim 1, wherein the first channel and the contact patterns satisfy 0.2 mm c′=(a−c)/2≤2 mm, wherein a represents a width of the first channel in the second direction, c represents a contact length of the contact patterns that is in contact with the second separator in the second direction, and c′ represents a length defined as (a−c)/2.

9. The electrochemical device of claim 1, wherein the first channel and the contact patterns satisfy 0.2 mm d′=(b−2e−d)/2≤2 mm, wherein b represents a distance between a first reference line and a second reference line spaced apart from each other at two opposite ends of the contact patterns in the first direction based on the contact patterns, e represents an interval between the contact patterns disposed adjacent to each other in the first direction, d represents a contact width of the contact patterns that are in contact with the second separator in the first direction, and d′ represents a length defined as (b−2e−d)/2.

10. The electrochemical device of claim 9, wherein the interval between the contact patterns is 1.5 mm or more.

11. The electrochemical device of claim 9, wherein the contact patterns and the second separator satisfy d<i, wherein i represents a width of the second land in the first direction.

12. The electrochemical device of claim 1, wherein the first channel and the contact patterns satisfy 0.4 mm≤h−g≤1.5 mm, wherein g represents a thickness defined as a sum of a thickness of the first separator and a thickness of the first channel, and h represents a thickness defined as a sum of a thickness of the first separator, a thickness of the first channel, and a thickness of the contact patterns.

13. The electrochemical device of claim 1, wherein the first channel comprises:
an inlet part;
a central part disposed at a downstream side from the inlet part; and
an outlet part disposed at a downstream side from the central part; and
wherein the contact patterns are provided on at least any one of the inlet part, the central part, and the outlet part.

14. An electrochemical device comprising:
a first separator comprising a first channel and a first land disposed in a first direction;
a second separator comprising a second channel and a second land disposed in a second direction intersecting the first direction, the second separator being stacked on the first separator; and
contact patterns provided on the first separator and disposed on the first channel so as to be in contact with the second separator, wherein each of the contact patterns comprises:
a contact portion spaced apart from the first separator and in contact with the second separator; and
a connection portion connecting the contact portion and the first separator.

15. The electrochemical device of claim 14, wherein the connection portion is in contact with the second separator.

16. The electrochemical device of claim 14, wherein the connection portion is in surface contact with the second separator.

17. The electrochemical device of claim 16, wherein the second land comprises:
a land contact portion spaced apart from the second separator; and
a land connection portion connecting the land contact portion and the second separator.

18. The electrochemical device of claim 17, wherein a boundary edge between the contact portion and the connection portion has a first radius, a boundary edge between the land contact portion and the land connection portion has a second radius smaller than the first radius, a boundary edge between the connection portion and the first separator has a third radius, and a boundary edge between the land connection portion and the second separator has a fourth radius larger than the third radius.

19. An electrochemical device comprising:
a first separator comprising a plurality of first channels and a plurality of first lands disposed in a first direction;
a second separator comprising a second channel and a second land disposed in a second direction intersecting the first direction, the second separator being stacked on the first separator, wherein the plurality of first channels and the plurality of first lands are alternately disposed in the second direction; and
contact patterns provided on the first separator and disposed at least any one of the plurality of first channels so as to be in contact with the second separator.

20. The electrochemical device of claim 19, wherein a first one of the contact patterns provided on any one of the plurality of first channels is spaced apart, in the first direction, from a second one of the contact patterns provided on another one of the plurality of first channels.
